(19) United States
(12) Patent Application Publication
(10) Pub. No.: US 2010/0282551 A1
(43) Pub. Date: Nov. 11, 2010

(54) BRAKE DISK

(75) Inventors: Michael Ruopp, Berghulen (DE); Franz Weiher, Neustetten (DE)

Correspondence Address: VOLPE AND KOENIG, P.C., UNITED PLAZA, 30 SOUTH 17TH STREET, PHILADELPHIA, PA, 19103, US

(73) Assignee: GUSTAV MAGENWIRTH GMBH & CO. KG, Bad Urach (DE)

(21) Appl. No.: 12/812,464

(22) PCT Filed: Jan. 16, 2009
(86) PCT No.: PCT/EP2009/000240

§ 371 Date: Jul. 12, 2010

(30) Foreign Application Priority Data
Jan. 19, 2008 (DE) 10 2008 005 169.1

(51) Int. Cl. F16D 65/12

(52) U.S. Cl. 188/218 XL

(57) ABSTRACT

A brake disk, preferably for an all-terrain vehicle (ATV), having an outer ring (2) and an inner ring (3), wherein the two rings (2, 3) are connected to one another in a floating fashion at a plurality of connecting points (5) using in each case one clamping connector (12). According to the invention, it is provided that the outer ring (2) and the inner ring (3) have catches (7, 8) that engage into one another in a positively locking fashion in the direction of rotation.

### BACKGROUND

The invention relates to a brake disk, in particular, for an all-terrain vehicle (ATV) with an outer ring and an inner ring, wherein these two rings are connected to each other in a floating fashion at several connection points by a clamping connector at each connection point.

Brake disks are typically one-piece components made from hardened metal. During a braking process, a brake caliper with brake linings is pressed onto the brake disk, so that high friction is generated between the brake disk and the brake lining. The friction converts the movement energy of the vehicle into heat that is dissipated almost completely via the brake disk. Here, the brake disk can become so hot that it deforms and the mounting is damaged or becomes fixed in the brake caliper.

In order to reduce the disadvantageous effects of the heat expansion of the brake disk, two-part brake disks are already used that are usually made from a hardened outer ring that is used as a contact face for the brake caliper and an inner ring for mounting the brake disk on a hub or an axle of the vehicle. The inner ring can be made from the same material as the outer ring or another material, for example, aluminum.

The outer and inner rings are connected in a floating fashion by clamping connectors—so-called floaters—so that the two disks can perform relative movements. Expansion of the outer ring due to heat is therefore not transferred to the inner ring to such a degree that the mounting of the brake disk is exposed to stress. Furthermore, the risk that the brake disk will become fixed in the brake caliper is reduced.

During operation, the forces occurring in the peripheral direction between the inner ring and the outer ring are transferred by the clamping connectors that are therefore exposed to high loads and wear. A worn clamping connector, however, does not contribute significantly to the transmission of torque between the outer and inner rings, wherein the brake disk immediately becomes unusable.

From U.S. Pat. No. 6,957,726 B2, a brake disk is known in which the torque is transmitted directly from the inner ring to the outer ring. For this purpose, the two rings each have contact faces that contact while rotating and receive the forces. The clamping connectors are here used only as securing devices in the axial direction. Therefore, the clamping connectors are no longer worn by torque transmission, which increases the service life. The shown brake disk, however, is imagined mainly for motorcycles in which the torque load usually occurs only in one rotational direction.

In the case of ATVs with four wheels, the brake disk is mounted on the wheel hub or the rim. Therefore, mechanical forces, such as bending forces, impacts, and shocks on the rim are also transmitted directly onto the brake disk. These bending forces can press the brake calipers back, making dosed braking more difficult or allowing the brake disk to become damaged.

### SUMMARY

Therefore, the objective of the invention is to create a brake disk for vehicles, in particular, for ATVs, wherein this brake disk withstands increased loads and provides higher functional security.

This objective is met in that the outer ring and the inner ring have catches that engage in each other, for example, in positive fit connections.

Therefore, if a clamping connector becomes worn or fails, the catches engaging in each other with a positive fit connection take over the force transmission in the rotational direction, so that the brake disk continues to be ready to use. This also prevents the clamping connector from wearing further.

The force transmission between the outer ring and inner ring in the rotational direction can also be optionally realized from the beginning exclusively or additionally by the catches. For the exclusive force transmission using the catches, the clamping connectors are used only for axial stabilization and for absorbing transverse forces and therefore there is no wear due to loading, wherein the durability and the service life of the brake disk are increased overall.

Preferably, catches engaging with clamping connectors with each other in a positive fit connection are arranged in the region of at least one connection point, because here the rings are arranged in any event close to each other and therefore relatively short and stable catches can be realized that do not contribute too much additional weight.

The catches can also be arranged alternatively or additionally between the connection points, wherein the arrangement has no influence on the function, but instead merely on the weight and the visual appearance of the brake disk.

Advantageously, the catches engaging in each other in a positive fit connection are each formed by at least one, approximately radially oriented protrusion or recess. Here it is useful when the catches on the outer ring are each formed by a radially inward projecting protrusion and when the catches on the inner ring are each formed by at least one radially outward projecting protrusion. To enable reliable operation in both rotational directions, a catch pair made from inner-ring and outer-ring catches can have an asymmetric configuration relative to the other catch pairs, wherein the two catches of the pair are arranged simply mirrored in the peripheral direction.

However, two catches spaced apart in the peripheral direction could also form an approximately U-shaped receptacle and these catches form, together with a catch of the counter ring, a pair, for example, an outer-ring catch can engage in an approximately U-shaped receptacle made from two inner-ring catches in one rotational direction.

Through an asymmetric or U-shaped arrangement of the catches, an operation of the brake disk is possible in both rotational directions, even if a clamping connector is worn or fails, which is important especially in vehicles that can also travel in reverse.

Three connection points with clamping connectors and catches for connecting the outer ring to the inner ring are usefully provided. Due to the small number of connection points, a larger degree of freedom of motion of the outer ring is achieved. In addition, the brake disk can be manufactured lighter and more easily and more economical.

In order to achieve sufficient freedom of motion, it is useful when a gap is provided between the two rings in the region of the connection points. Here, a radial gap could be provided between the catches, wherein the radial measure of this gap equals up to approximately 2 mm, advantageously approximately 0.75 mm.

Furthermore, a gap could be provided between the catches in the rotational direction, wherein the gap measure between the catches equals preferably up to approximately 1 mm, advantageously approximately 0.25 mm.

Advantageously, the clamping connectors provided in the region of the connection points are formed in two pieces with a stop bolt and a securing disk, wherein advantageously at least one of the two clamping connector parts is supported with a corrugated spring against the rings so that it can move in the axial direction. In practice, a two-sided support of the rings is usually provided by corrugated springs. Through this increased freedom of motion, the two rings are easily decoupled from each other, wherein higher operational reliability is achieved.

The clamping connector here sits in the region of a connection point in approximately half-shell-shaped recesses of the two rings. Each clamping connector, however, could also be arranged directly between the rings.

The clamping-connector parts can be connected rigidly after the assembly, for example, riveted, soldered, or using a different non-positive-fit connection. It is also possible, however, that the clamping connector parts are screwed or held by detachable securing elements. This maintains the possibility of disassembling the clamping connections and exchanging the outer ring separate from the inner ring.

To guarantee sufficiently long service life, the outer ring is preferably made from hardened steel. The inner ring advantageously consists of steel or hardened steel, but could also be made from other metals or metal alloys, such as, for example, aluminum.

In particular, the inner and outer ring could also be made from one part, for example, by laser cutting. Therefore, the production is simple and economical, because both parts can be made in one processing step. Here, the gap widths in the region of the catches automatically correspond to the cutting width of the laser beam.

One useful refinement of the invention provides that at least one catch is constructed as a wear indicator. For this purpose, the inner ring could be advantageously made from anodized aluminum. When the clamping connector wears, play is created in the peripheral direction of the brake disk and the catches bump against each other in a friction-generating way, wherein the anodization is worn off. The catch prevents the further wear of the clamping connector and simultaneously indicates as soon as a catch is worn bare. Thus, without additional expense, a simple visual inspection of the brake disk can be performed for wear. Obviously, other wear indicators are also conceivable, such as, for example, a tongue-shaped protrusion with a desired fracture point that breaks away under a certain force loading.

### BRIEF DESCRIPTION OF THE DRAWINGS

The invention is explained in detail below with reference to the drawings.

Shown are:

FIG. 1 a side view of a brake disk according to the invention,

FIG. 2 a detailed view of the brake disk in the region of a connection point,

FIG. 3 a section view of the brake disk in the region of a connection points, and

FIG. 4 a side view of another construction of a brake disk according to the invention.

### DETAILED DESCRIPTION OF THE PREFERRED EMBODIMENTS

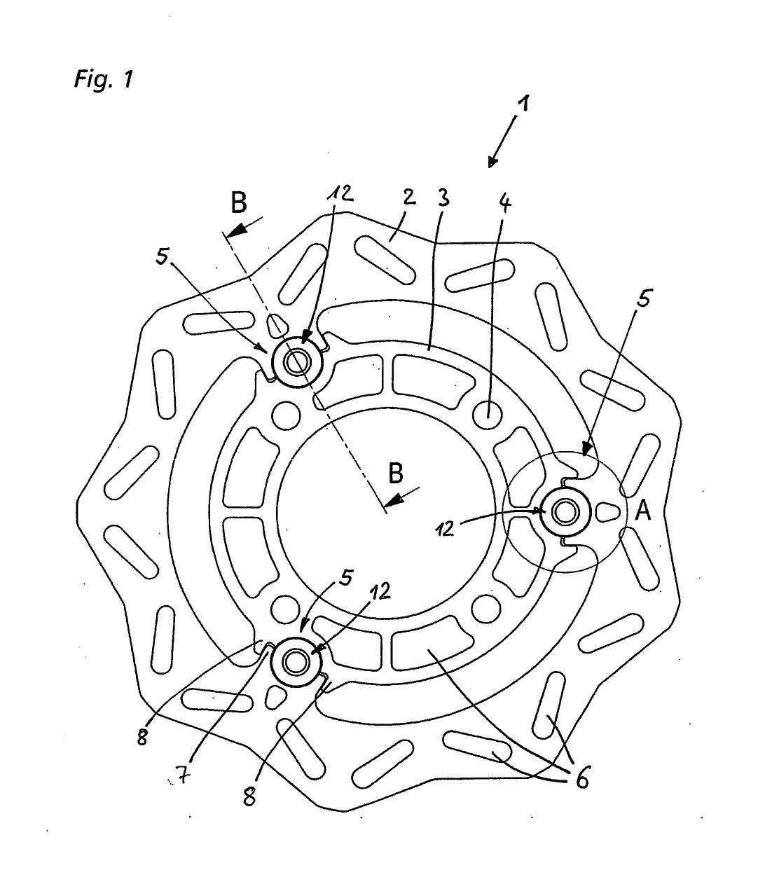

FIG. 1 shows a two-part brake disk designated as a whole with 1,in particular, for an all-terrain vehicle (ATV) with an outer ring 2 as a friction ring, with brake linings that are not shown here engaging this friction ring, and with an inner ring 3 for mounting the brake disk 1 on a hub or rim of a vehicle. For this purpose, the inner ring has four attachment holes 4, wherein this number is dependent on the rim/hub manufacturer. Both the outer ring 2 and also the inner ring 3 have numerous recesses 6 that are used for weight reduction and quick heat dissipation.

The outer ring 2 and the inner ring 3 are connected at three connection points 5 distributed uniformly on the periphery at a spacing of 120° , wherein a clamping connector 12 engages at each connection point in approximately half-shell-shaped recesses of the two rings 2, 3. The regions of the two rings 2, 3 located in the peripheral direction next to each clamping connector 12 have catches 7, 8 that then engage in each other with a positive-fit connection on the half-shell-shaped recesses, so that the two rings 2, 3 are locked against twisting in the rotational direction relative to each other, even if the clamping connector 12 should fail.

On the outer ring 2, the catches 7 are each formed by the free, radially inward pointing ends of the half-shell-shaped recess, wherein cavities are adjacent to these catches 7 laterally in the rotational direction.

On the inner ring 3, catches 8 are likewise arranged in the region of the connection points 6, wherein these catches point essentially radially outward and project in an overlapping manner past the outsides of the catches 7 of the outer ring 2. They each form an approximately U-shaped receptacle for the catches 7 of the outer ring 2.

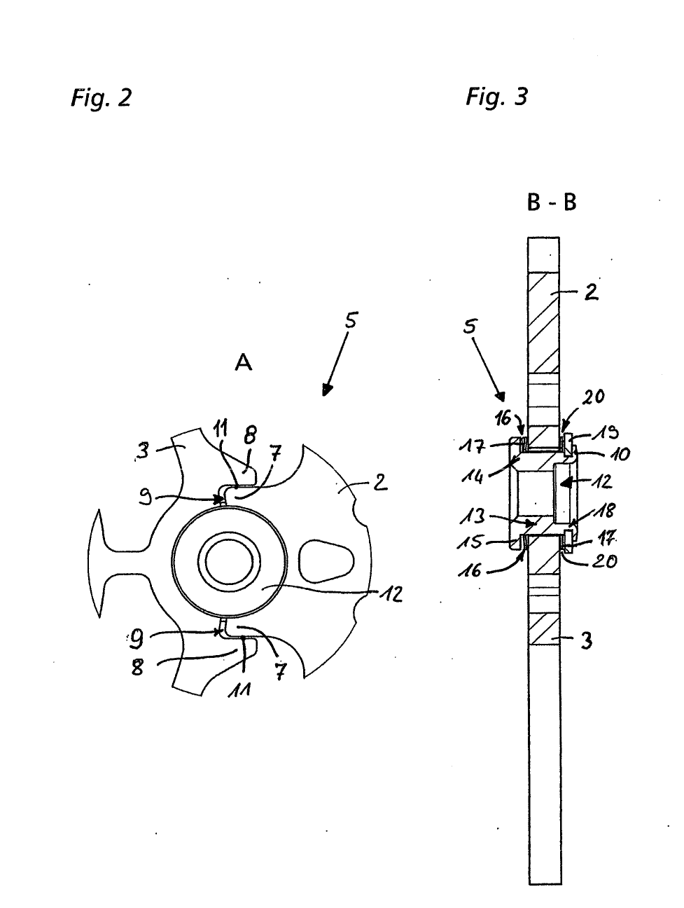

Between the catches 7 and 8 there is a gap 9 in approximately a radial direction and a gap 11 (FIG. 2) in the peripheral or rotational direction, so that, despite the positive-fit connection, there is still freedom of motion between the outer ring 2 and the inner ring 3 in the peripheral direction.

The radial gap 9 between the catches 7, 8 can be approximately 0.75 mm and the gap 11 in the peripheral direction between the inner-ring catch 7 and the outer-ring catches 8 can be approximately 0.25 mm wide.

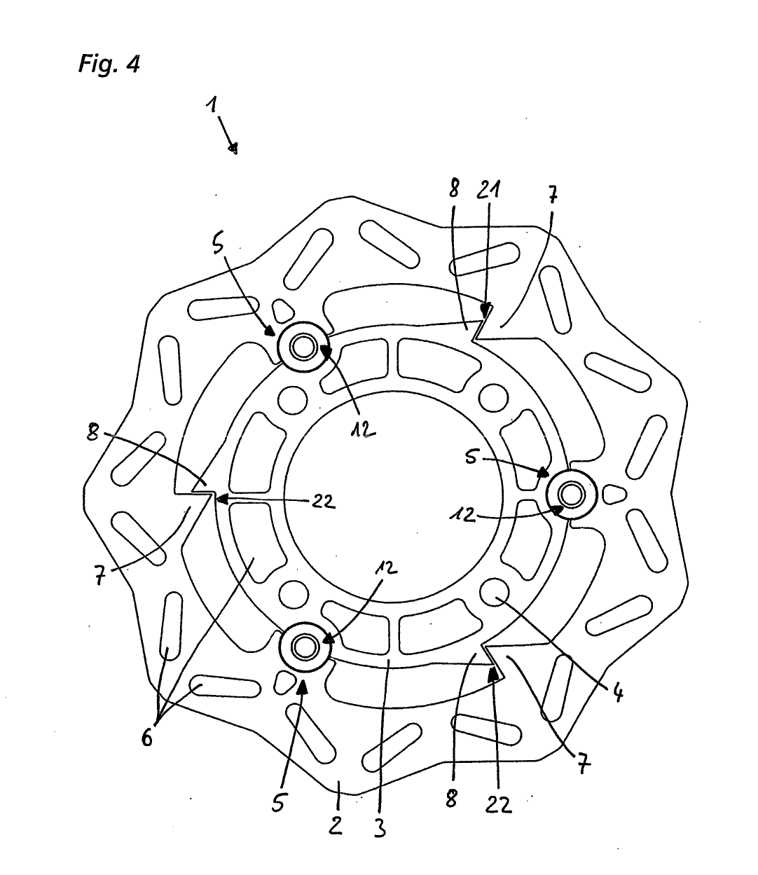

The outer ring 2 and the inner ring 3 are connected at each connection point 5 by a clamping connector 12 or its side position is secured relative to each other. As can be seen in FIG. 3, the clamping connector 12 has a stop bolt 13 that passes through the rings 2, 3 and engages between the outer ring 2 and the inner ring 3 in the half-shell-shaped recesses of the two rings 2, 3. On one end 14, the stop bolt 13 has a disk-shaped stop head 15 and is connected on the other end 18 to a securing disk 19. The securing disk 19 is connected by a flange 10 to the stop bolt 13.

Gaps 16, 20 in which corrugated springs 17 are inserted are provided between the stop head 15 and the one side of the two rings 2, 3, as well as the securing disk 19 and the other side of the two rings 2, 3. In this way, the two rings 2, 3 are held so that they can move to a limited extent in the axial transverse direction, so that the rings 2, 3 can perform axial relative movements.

In contrast to the brake disk shown in FIG. 1, the brake disk 1 shown in FIG. 4 has catches 7, 8 that are arranged spaced apart from the connection points 5 with clamping connectors 12 in the peripheral direction. In the peripheral direction, approximately in the center between the connection points, three catches 7, 8 that engage into each other with positive-fit connections in the peripheral direction are arranged on the inner ring 3 and on the outer ring 2. These catches are each formed from an essentially sawtooth-shaped protrusion. A catch pair 21 is mirrored relative to the two other catch pairs 22 in the peripheral direction, so that the catches engage into each other with a positive-fit connection in both rotational directions. Preferably, the catches are arranged so that two catch pairs 22 are aligned according to the main rotational direction and the individual catch pair 21 acts, for example, in the reverse direction of travel.

1. Brake disk for an all-terrain vehicle (ATV), comprising an outer ring (2) and an inner ring (3), wherein the outer and inner rings (2, 3) are connected to each other in a floating fashion at multiple connection points (5) by a clamping connector (12) at each of the connection points, the outer ring (2) and the inner ring (3) have catches (7, 8) that engage with each other with a positive-fit connection in a rotational direction.

2. Brake disk according to claim 1, wherein the catches (7, 8) engage with each other with the positive-fit connection in both rotational directions.

3. Brake disk according to claim 1, wherein in a region of at least one of the connection points, the catches engage with each other and the clamping connectors with the positive-fit connection.

4. Brake disk according to claim 1, wherein the catches (7, 8) engaging with each other with the positive-fit connection are each formed by at least one, approximately radially oriented protrusion or recess.

5. Brake disk according to claim 1, wherein each of the catches (7) are formed on the outer ring (2) by at least one approximately radially inward projecting protrusion.

6. Brake disk according to claim 5, wherein each of the catches (8) on the inner ring (3) are formed by at least one approximately radially outward projecting protrusion.

7. Brake disk according to claim 1, wherein two of the catches (8) spaced apart in the peripheral direction on the inner ring or the outer ring form an approximately U-shaped receptacle.

8. Brake disk according to claim 7, wherein the approximately U-shaped receptacle is on the inner ring (3) and surrounds an outer-ring catch (7) in the rotational direction.

9. Brake disk according to claim 7, wherein three of the connection points (5) are provided with the clamping connectors and three of the outer-ring catches, as well as three of the U-shaped receptacles on the inner ring (7, 8) are arranged engaging with each other with the positive-fit connection in the region of the connection points (5).

10. Brake disk according to claim 1, wherein three of the connection points (5) are provided with the clamping connectors and the catches (7, 8) are arranged one engaging in the other with the positive-fit connection in the peripheral direction between the connection points (5).

11. Brake disk according to claim 1, wherein a radial gap (10) is provided that equals up to approximately 2 mm between the catches (7, 8).

12. Brake disk according to claim 1, wherein a gap is provided in the rotational direction between the catches (7, 8), wherein the gap equals up to approximately 1 mm.

13. Brake disk according to claim 1, wherein the two rings (2, 3) are secured in the axial direction in the region of the connection points (5) by the clamping connectors (12).

14. Brake disk according to claim 1, wherein the clamping connectors (12) are formed in two parts with a stop bolt (13) and a securing ring (19) and at least one of the two clamping-connector parts (13, 19) is supported with a corrugated spring (17, 21) so that it can move axially against the rings (2, 3).

15. Brake disk according to claim 14, wherein the two clamping-connector parts (13, 19) are riveted.

16. Brake disk according to claim 15, wherein the two clamping-connector parts (13, 19) are screwed together.

17. Brake disk according to claim 1, wherein the outer ring (2) is made from hardened steel.

18. Brake disk according to claim 1, wherein the inner ring (3) is made from aluminum, steel, or hardened steel.

19. Brake disk according to claim 1, wherein the inner (3) and outer rings (2) are made from one part by laser cutting.

20. Brake disk according to claim 1, wherein at least one catch (7, 8) is constructed as a wear indicator.
